(19) United States
(12) Patent Application Publication
(10) Pub. No.: US 2014/0020841 A1
(43) Pub. Date: Jan. 23, 2014

(54) FILM AFFIXING APPARATUS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: QIU-SHENG LU, Shenzhen (CN); DONG-YUE WU, Shenzhen (CN); JUN ZHANG, Shenzhen (CN); ZHAO-YONG LI, Shenzhen (CN)

(21) Appl. No.: 13/940,228

(22) Filed: Jul. 11, 2013

(30) Foreign Application Priority Data
Jul. 20, 2012 (CN) 2012102522007

(51) Int. Cl. B32B 37/00

(52) U.S. Cl. CPC B32B 37/0046
USPC 156/494; 156/538

(57) ABSTRACT

A film affixing apparatus for affixing a film to a workpiece includes a stand, a film provider, and an affixing device. The stand includes a work platform. The workpiece slides along the work platform under an external force. The film provider is mounted to the stand and dispenses rolls of film. The affixing device is mounted to the stand. The affixing device includes a pressing portion that faces the work platform. The film is unwound and passes over the pressing portion onto the workpiece on the work platform. The pressing portion presses the film onto the workpiece.

### BACKGROUND

1. Technical Field

The present disclosure relates to a film affixing technology, particularly to a film affixing apparatus for automatically affixing a film to an object.

2. Description of Related Art

A surface of a device or a component is always affixed with a film for preventing the device from being accidentally scratched. However, the film is typically affixed to the device or the component manually, which takes a lot of time for the operators.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a film affixing apparatus with loaders in accordance with an embodiment. The film affixing apparatus includes a work platform.

FIG. 2 is an isometric view of the film affixing apparatus in FIG. 1 with one of the loaders separated from it.

FIG. 3 is an isometric view of the platform in FIG. 1.

FIG. 4 is the film affixing apparatus viewed from another aspect.

FIG. 5 is an isometric view of the film affixing apparatus in FIG. 4 viewed from another aspect.

FIG. 6 is the film affixing apparatus in FIG. 1 viewed from another aspect.

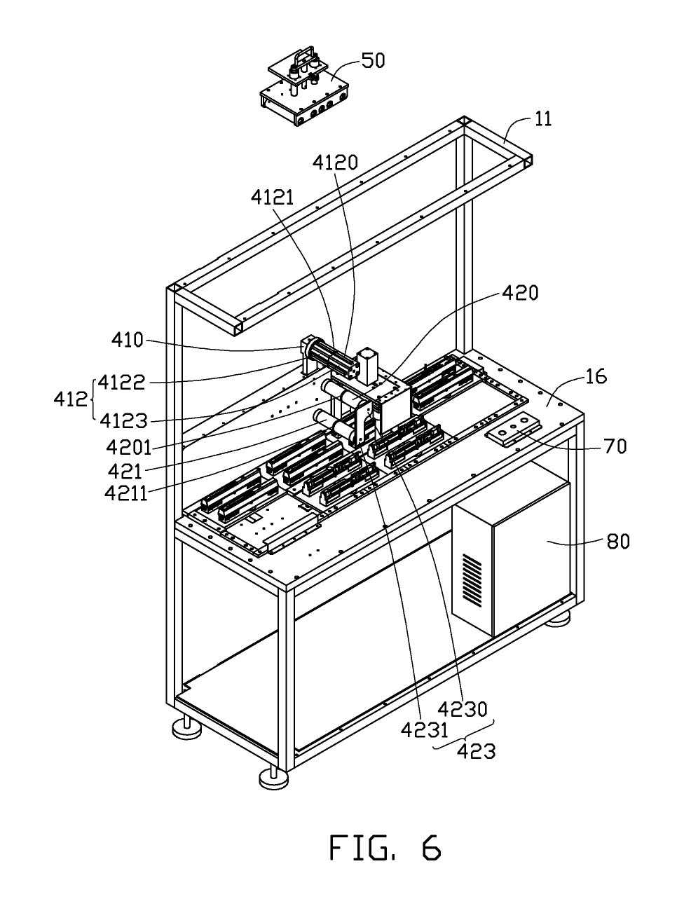

FIG. 7 is an exploded view of an affixing device.

### DETAILED DESCRIPTION

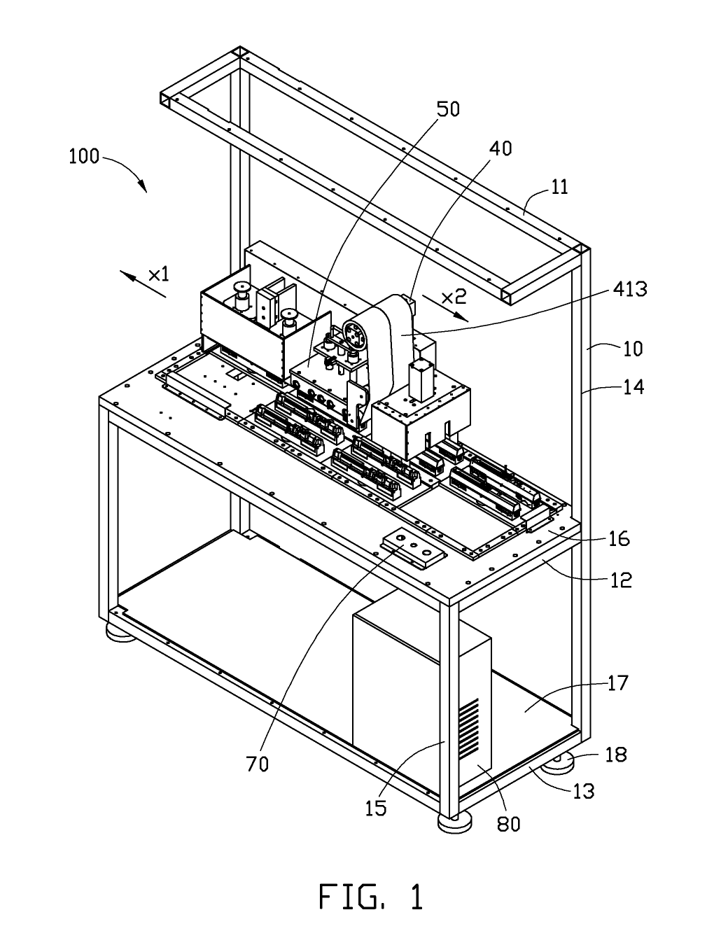

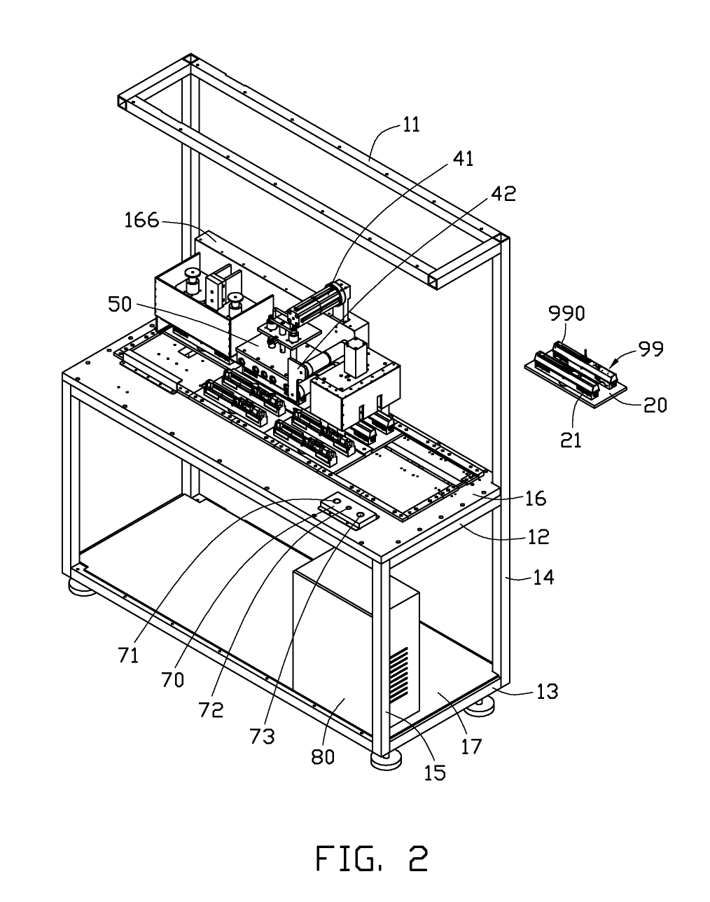

FIGS. 1 and 2 show an embodiment of a film affixing apparatus 100. The film affixing apparatus 100 affixes a film to workpieces 99. The workpieces 99 include rectangular top surfaces 990, which require to be covered with film.

The film affixing apparatus 100 includes a stand 10, a plurality of loaders 20, a film provider 40, an affixing device 50, an operating box 70, and a control box 80. The loader 20 includes two positioning parts 21 not attached to each other. Each positioning part 21 is configured to position one workpiece 99.

The stand 10 includes a top frame 11, a work frame 12, a holding frame 13, two first legs 14, two second legs 15, a work platform 16, a holding platform 17, and four supporting stands 18. The top frame 11, the work frame 12 and the holding frame 13 are parallel, and the work frame 12 is located between the top frame 11 and the holding frame 13. The work frame 12 and the holding frame 13 are the same size, and a width of the top frame 11 is smaller than a width of the work frame 12. The two first legs 14 are both connected to the top frame 11, the work frame 12, and the holding frame 13 and are arranged on the same side of the top frame 11, the work frame 12 and the holding frame 13. The two second legs 15 are both connected to the work frame 12 and the holding frame 13 and are opposite to the two first legs 14. The four supporting stands 18 are arranged on the holding frame 13 to make the stand 10 stand off from the floor. The holding platform 17 is rectangular and placed on the holding frame 13. The work platform 16 is rectangular and placed on the work frame 12.

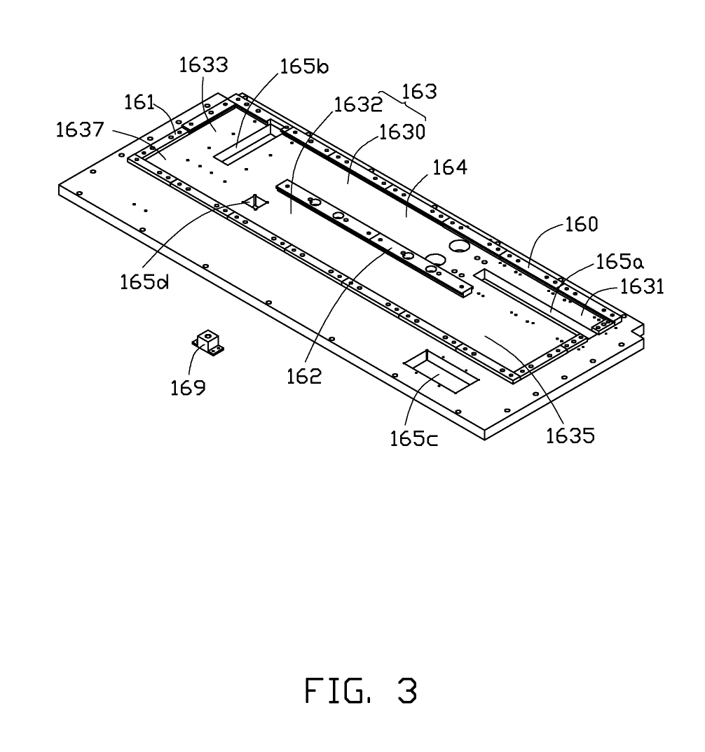

FIG. 3 shows an embodiment of the work platform 16. The work platform 16 is a substantially rectangular board. Two first blocking bars 160, two second blocking bars 161, and a third blocking bar 162 are arranged on one surface of the work platform 16. The two first blocking bars 160 are parallel. The two second blocking bars 161 are parallel and are connected between the first blocking bars 160. The second blocking bars 161 and the first blocking bars 160 cooperatively define a rectangular work region 163. The third blocking bar 162 is positioned in the middle of the work region 163 and is parallel to the first blocking bars 160. The third blocking bar 162 is shorter than the first blocking bars 160, such that opposite distal ends of the third blocking bar 162 are separated from the two second blocking bars 161. The third blocking bar 162 divides the work region 163 into an operating region 1630 and a waiting region 1632 for receiving the loaders 20, and the operating region 1630 is on the side of the work platform 16 connected to the first legs 14. The operating region 1630 and the waiting region 1632 are symmetrical with respect to the third blocking bar 162. The operating region 1630 is capable of receiving four loaders 20. The operating region 1630 includes a first end 1631 and a second end 1633 opposite to the first end 1631. The waiting region 1632 includes a third end 1635 and a fourth end 1637 opposite to the third end 1635. The first end 1631 and the third end 1635 meet each other, and each of them is capable of receiving one loader 20. The second end 1633 and the fourth end 1637 meet each other, and each of them is capable of receiving one loader 20.

The work platform 16 further has a work station 164 and a mounting part 166 and defines a first opening 165a, a second opening 165b, a third opening 165c, and a fourth opening 165d. The first opening 165a, the second opening 165b, and the work station 164 are located in the operating region 1630. The work platform 16 is capable of receiving one loader 20 in the work station 164. The first opening 165a and the second opening 165b are rectangular and respectively defined in the first end 1631 and the second end 1633. The first opening 165a runs along a first direction X parallel to the first blocking bars 160. The second opening 165b runs along a second direction Y parallel to the second bars 161. The third opening 165c is arranged at one side of the waiting region 1632 and away from the operating region 1630. The fourth opening 165d is defined in the fourth end 1637. The mounting part 166 is a rectangular board and protrudes from one side of the work station 164 adjacent to the operating region 1630.

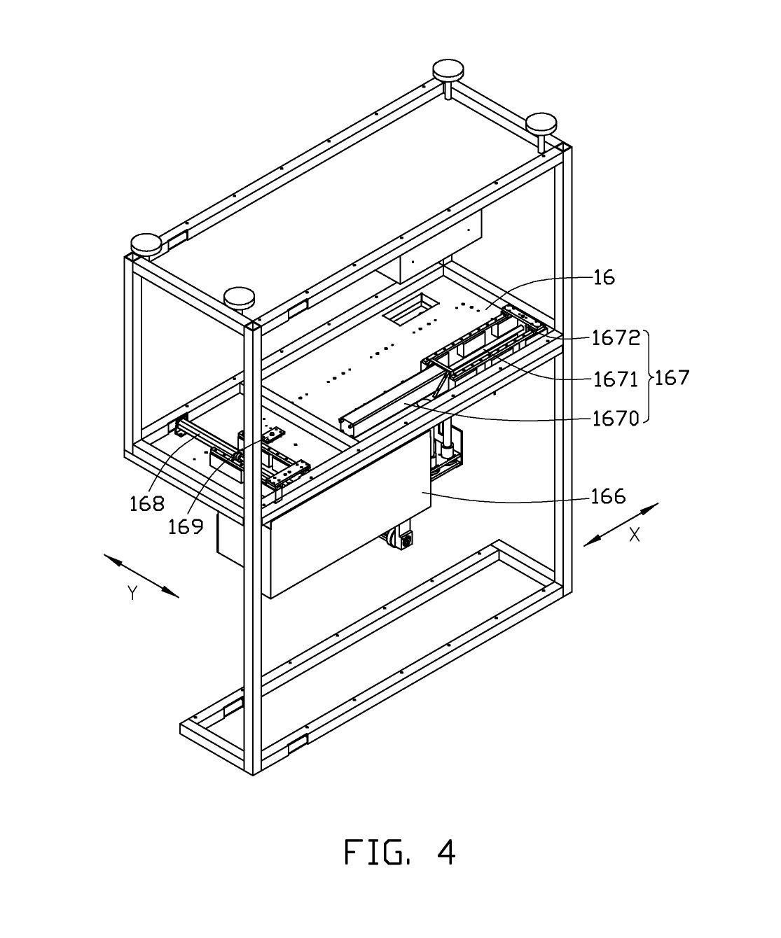

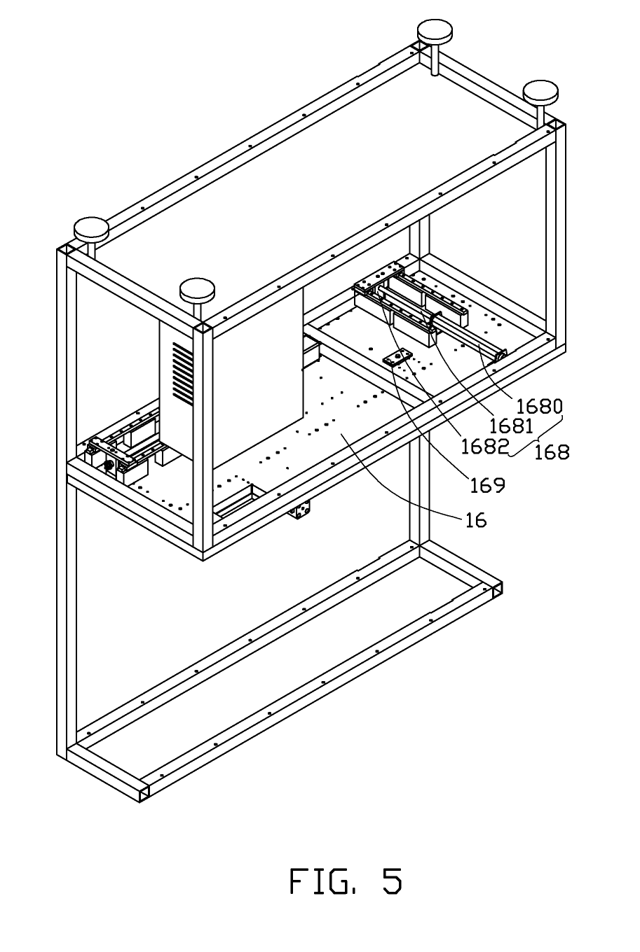

Referring to FIGS. 4 and 5, a first driving device 167, a second driving device 168, and a sensor 169 are further set on the work platform 16. The first driving device 167 and the second driving device 168 are arranged on one surface of the work platform 16. The first driving device 167 drives the loaders 20 to move in a first direction X parallel to the first blocking bars 160. The second driving device 168 drives the loaders 20 to move in a second direction Y parallel to the second blocking bars 161.

The first driving device 167 includes a first driving body 1670, a first driving arm 1671, and a first driving block 1672. The first driving body 1670 is adjacent to the first opening 165a, the first driving arm 1671 extends along the length of the first opening 165a, and the first driving block 1672 is received in the first opening 165a. The first driving block 1672 is secured on an end of the first driving arm 1671 away from the first driving body 1670. The first driving body 1670 drives the first driving arm 1671 to move from one end of the first opening 165a to an opposite end, causing the driving block 1672 to move along the first direction X towards and away from the second end 1633. In its original state, the first driving block 1672 is positioned at the side of the first end 1631 away from the second end 1633, such that the first driving block 1672 abuts one side of the loader 20 away from the second end 1633. The driving block 1672 pushes the loader 20 towards the second end 1633 as the first driving arm 1671 is caused to move along the X direction towards the second end 1633.

The second driving device 168 includes a second driving body 1680, a second driving arm 1681, and a second driving block 1682. The second driving body 1680 is adjacent to the second opening 165b. The second driving arm 1681 is connected to the second driving body 1680 and extends along the length of the second opening 165b. The second driving block 1682 is fixed on the end of the second driving arm 1681 away from the second driving body 1680 and is received in the second opening 165b. The second driving body 1680 drives the second driving arm 1681 to move in the second direction Y. The second driving block 1682 moves along the second direction Y along with the second driving arm 1681 towards and away from the fourth end 1637. In its original state, the second driving block 1682 is positioned at one side of the second end 1633 away from the fourth end 1637. The second driving block 1682 abuts one side of the loader 20 away from the fourth end 1637 so that the driving block 1682 pushes the loader 20 toward the fourth end 1637 when the second driving arm is caused to move along the second direction Y toward the fourth end 1637. In this way, the first driving device 167 and the second driving device 168 cooperatively drive the workpieces 99 loaded on the loader 20 to loop around the work region 163.

The sensor 169 is located in the fourth opening 165d for detecting whether the loader 20 or another object is positioned at the fourth end 1637.

Referring to FIGS. 1,2 and 6, the film provider 40 and the affixing device 50 are arranged on the operating region 1630 and face the work station 164. The affixing device 50 is adjacent to the film provider 40 and is away from the first end 1631. The film provider 40 includes a hanging member 41 and a stretching member 42. The hanging member 41 includes a supporting element 410 and a hanging element 412. The supporting element 410 protrudes upwards from one side of the mounting part 166 away from the platform 16. The hanging element 412 is cuboid, and extends perpendicularly from one end of the supporting element 410 away from the mounting part 166 to the work platform 16. Four ribs 4120 protrude from four side walls of the hanging element 412. Three tabs 4121 protrude from opposite ends and the middle of each rib 4120 so as to divide the hanging element 412 into a first hanging portion 4122 and a second hanging portion 4123. The first hanging portion 4122 and the second hanging portion 4123 are sleeved by two rolls of films 413 which unwind straight down.

The stretching member 42 includes a first stretching element 420, a second stretching element 421, and a connecting element 423. The first stretching element 420 and the second stretching element 421 are columns and are substantially the same. The middle of the first stretching element 420 defines a groove 4201, and the middle of the second stretching element 421 defines a groove 4211. The first stretching element 420 and the second stretching element 421 perpendicularly project from one side of the mounting part 166 and are parallel to the hanging element 412. The first stretching element 420 is positioned between the second stretching element 421 and the hanging element 412. The connecting element 423 includes a first rectangular base 4230 and a second rectangular base 4231 that extends from one end of the first base 4230. The first base 4230 is connected to one end of the first stretching element 420 away from the mounting part 166. The second base 4231 is connected to one end of the second stretching element 421 away from the mounting part 166. The two rolls of the films 413 spread over and cover the first stretching element 420 and the second stretching element 421 in that order, and then winds around the affixing device 50 such that the film 413 is tightened via the first stretching element 420 and the second stretching element 421. Furthermore, the two rolls of the films 413 are separated from each other via the grooves 4201 and 4211.

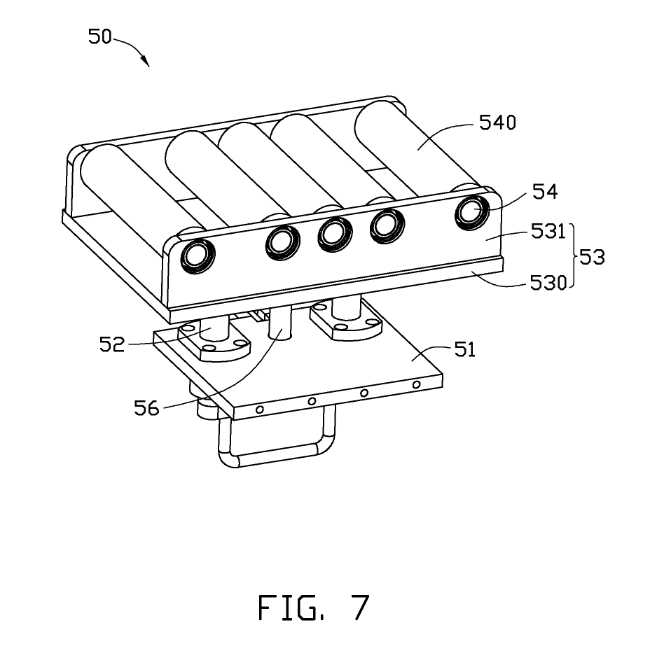

Referring to FIG. 7, the affixing device 50 includes a fixing board 51, two first connecting poles 52, a second connecting pole 56, a mounting case 53, and five rollers 54. The fixing board 51 is rectangular and parallel to the work platform 16. One side of the fixing board 51 is fastened to the mounting part 166. The fixing board 51 faces the work station 164. One end of the first connecting poles 52 and the second connecting pole 56 is mounted to the fixing board 51, and the other end is mounted to the mounting case 53. The first connecting poles 52 and the second connecting pole 56 are columnar, and a diameter of a first connecting pole 52 is smaller than a diameter of the second connecting pole 56. The first connecting poles 52 and the second connecting pole 56 are arranged in a line, and the first connecting poles 52 are symmetrically arranged on two sides of the second connecting pole 56. The mounting case 53 includes a top portion 530 and two side walls 531 extending from two opposite sides of the top portion 530. The two side walls 531 are parallel to the mounting part 166. One side of the top portion 530 away from the side walls 531 is connected to the first connecting poles 52 and the second connecting pole 56, and the second connecting pole 56 is positioned in the middle of the top portion 530 to balance the mounting case 53. The rollers 54 are columnar and have the same size. Each roller 54 is rotatably connected between the side walls 531, and each roller 54 is perpendicular to the mounting part 166. The five rollers 54 are arranged on a plane and rise above the side walls 531 to form a pressing portion 540 parallel to the work platform 16. The pressing portion 540 faces the work station 164. The loaders 20 loading the workpieces 99 pass between the rollers 54 and the work station 164, and the pressing portions 540 press on the top surfaces 990 of the workpieces 99 when the loaders 20 pass between the rollers 54 and the work station 164.

The control box 80 is arranged on the holding platform 17 to control the first driving device 167 and the second driving device 168 to enable the affixing device 50 to affix film 143 to the workpieces 99. The control box 80 pauses when the sensor 169 detects an object.

The operating box 70 is secured in the third opening 165c to control the control box 80. The operating box 70 includes a start button 71, a stop button 72, and an indicator 73. The start button 71 is pressed to start the control box 80. The stop button 72 is pressed to stop the control box 80. The indicator 73 informs the operator if the film affixing apparatus 100 is abnormal, allowing the operator to stop the control box 80 by pressing the stop button 72 or placing an object in the fourth end 1637.

In operation, the waiting region 1632 is fully filled with the loaders 20, and each loader 20 loads two workpieces 99. There is no loader positioned in the operating region 1630. Next, the film 413 spreads over the first stretching element 420 and the second stretching element 421 in a third direction x1 parallel to the first direction X, runs in a fourth direction x2 opposite to the third direction x1 to locate between the stretching member 42, and passes out of the affixing device 50 along the third direction x2. Then, a first loader 20 positioned at the third end 1635 is pulled to the first end 1631 manually or by a pulling device (not shown). Then, the start button 71 is pressed manually or by a pressing device (not shown), and the control box 80 controls the first driving body 1670 to drive the first driving arm 1671 to move a predetermined distance equal to the length of the loader 20 along the first direction X so as to enable the first driving block 1672 to push the first loader 20 towards the work station 164. Next, a second loader 20 is pulled from the waiting region 1632 via the third end 1635 to the first end 1631, the start button 71 on the control box 80 is pressed, and the first driving block 1672 pushes the second loader 20, which pushes the first loader 20 into the work station 164 and under the film 413. The pressing portion 540 presses the film 413 onto the top surfaces 990 of the two workpieces 99, and the film 413 is affixed to the top surface 990. This process is repeated until the first loader is positioned at the second end 1633. At this point, the control box 80 controls the second driving body 1680 to drive the second driving arm 1681 to push the first loader 20 a second predetermined distance along the second direction Y into the fourth end 1637 allowing the first loader 20 to be easily removed from the work platform 16, ending the process for the first loader 20. The workpieces 99 loaded onto the subsequent loaders 20 are affixed with the film 413 according to the above operations.

As described above, the film affixing apparatus 100 automatically affixes the film 413 to the workpieces 99, which is more convenient than affixing them manually. Furthermore, the film affixing apparatus 100 can affix the film 413 to two workpieces 99 at the same time, doubling the efficiency.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A film affixing apparatus for affixing a film to a workpiece, the film affixing apparatus comprising:
a stand with a work platform, the workpiece being capable of sliding on the work platform under an external force;
a film provider mounted to the stand, the film provider dispensing a film; and
an affixing device mounted to the stand, the affixing device comprising a first side, a second side opposite to the first side, and a pressing surface connected between the first side and the second side, the pressing surface facing the work platform, the film passing the pressing surface from the first side to the second side to position between the pressing surface and the workpiece sliding on the work platform;
wherein the pressing surface presses the film to the workpiece during the workpiece sliding to pass the pressing surface.

2. The film affixing apparatus of claim 1, wherein the affixing device comprises a mounting casing, and at least one roller rotatably mounted to the mounting casing, the mounting casing is mounted to the stand and above the work platform, the circumferential surface of the at least one roller protrudes out of the mounting casing to form the pressing surface, and the at least one roller rotates during the workpiece sliding from the first side to the second side.

3. The film affixing apparatus of claim 2, wherein the film is further unwounded when the workpiece slides away from the second side.

4. The film affixing apparatus of claim 1, wherein the affixing device comprises a mounting casing, and a plurality of rollers rotatably mounted to the mounting casing, the mounting casing is mounted to the stand and above the work platform, the rollers are parallelly arranged from the first side to the second side, circumferential surfaces of the plurality of the rollers protrude out of the mounting casing to form the pressing surface, and the rollers rotate during the workpiece sliding to pass the pressing surface.

5. The film affixing apparatus of claim 4, wherein the plurality of rollers are arranged by making their circumferential surfaces be arranged on a plane.

6. The film affixing apparatus of claim 1, wherein the film provider comprises a hanging element, at least one tab protruding from the middle of the hanging element to divide the hanging element into a first hanging portion and a second hanging portion, each of the first hanging portion and the second hanging portion is wound by the film.

7. The film affixing device of claim 6, wherein the film provider further comprises a stretching member, the stretching member is positioned at one side of the hanging element and away from the second side, the film passes to the stretching member in a first direction, and turns to the second direction opposite to the first direction to pass out of the affixing device to tighten the film.

8. The film affixing device of claim 7, wherein the stretching member comprises a first stretching element and a second stretching element, the first stretching element is positioned at one side of the second stretching element away from the first side, and above the second stretching member.

9. The film affixing device of claim 7, wherein each of the first stretching element and the second stretching element defines a groove.

10. The film affixing device of claim 6, further comprising a loader sliding on the work platform, the loader comprising two positioning members, each of the positioning members positioning one workpiece.
